(19) United States
(12) Patent Application Publication
(10) Pub. No.: US 2016/0039088 A1
(43) Pub. Date: Feb. 11, 2016

(54) Vehicle Service Platform

(71) Applicant: Darrell Wesley Blasjo, Pinon Hills, CA (US)

(72) Inventor: Darrell Wesley Blasjo, Pinon Hills, CA (US)

(21) Appl. No.: 14/821,545

(22) Filed: Aug. 7, 2015

Related U.S. Application Data
(60) Provisional application No. 62/034,392, filed on Aug. 7, 2014.

(51) Int. Cl. B25H 5/00

(52) U.S. Cl. CPC B25H 5/00

(57) ABSTRACT

A vehicle service platform supporting a user while working underneath a dashboard of a vehicle. The vehicle service platform includes an upper frame, a lower frame, a scissor lift, a jackscrew, a plurality of casters, a support cushion, a headrest and an actuating crossbar. The user actuates the jackscrew to raise the upper frame from the lower frame through scissor lift and the actuating crossbar mounted to the scissor lift. The plurality of casters allow the vehicle service platform to be maneuverable around the vehicle to access the dashboard from the driver side or passenger side of the vehicle. The support cushion and the headrest provide a comfortable surface for the user to lay supine while working on the vehicle. The headrest is able to be angled to the user's preference for better access and viewing under the dashboard.

The current application claims a priority to the U.S. Provisional Patent application Ser. No. 62/034,392 filed on Aug. 07, 2014.

### FIELD OF THE INVENTION

The present invention relates generally to a vehicle service platform for facilitating access to the space underneath a dashboard. More specifically, the present invention is a service platform that allows the user to conveniently access the space underneath a vehicle dashboard by incorporating a cantilevered surface that extends into the interior of the vehicle to provide the user with a flat and stable base while working underneath the dashboard.

### BACKGROUND OF THE INVENTION

A vehicle dashboard serves as the driver's control panel and houses various controls, instrumentation, and electronics for proper operation of the vehicle. The dashboard generally comprises the vehicle steering wheel as well as instrumentation/controls for various vehicle features such as the headlights, turn signal lights, and windshield wipers. In addition, the dashboard features a backlit panel on which a large number of indicator lights relating to various vehicle functions are displayed. Maintenance and service on a vehicle generally requires a technician to access the cramped space underneath the dashboard of the vehicle, a task that is cumbersome and uncomfortable even for technicians of smaller stature. Performing service underneath a dashboard is difficult as a technician must often have access to a wide variety of tools and instruments. If the technician requires a tool after entering the vehicle, the technician must first exit the vehicle to acquire the tool and then reenter the space between the dashboard and the vehicle floor. Auto mechanics and technicians frequently make use of a creeper, a tool designed to facilitate access to an otherwise difficult-to-access region of a vehicle. However, when attempting to access the space between the dashboard and vehicle floor, a creeper is generally inadequate as the tool does not sufficiently extend into the interior of the vehicle. The present invention seeks to address the aforementioned issues relating to dashboard and vehicle maintenance as well as provide the user with a practical, straightforward, and convenient solution.

The present invention is a service platform that is designed to aid the user in accessing the cramped space between the dashboard and floor of a vehicle when performing maintenance and service. The present invention allows a user to manipulate an upper frame through a scissor lift in order to distance the upper frame from a lower frame. Setting this distance allows the user to position the upper frame into a vehicle where the user is able to conveniently access the dashboard from underneath.

### BRIEF DESCRIPTION OF THE DRAWINGS

FIG. 1 is a perspective view of the present invention in a collapsed configuration.

FIG. 2 is a perspective view of the present invention in a collapsed configuration having the support cushion and the headrest removed.

FIG. 3 is a perspective view of the present invention in an expanded configuration having the support cushion and the headrest removed.

FIG. 4 is a detailed view of the headrest being positioned in an angled configuration.

FIG. 5 is a detailed cross-sectional view of the helical threading of the jackscrew interfacing with the female-threaded hole of the actuating crossbar of the present invention.

FIG. 6 is a schematic view for either the first lifting mechanism or the second lifting mechanism of the present invention.

### DETAIL DESCRIPTIONS OF THE INVENTION

All illustrations of the drawings are for the purpose of describing selected versions of the present invention and are not intended to limit the scope of the present invention.

The present invention is a vehicle service platform to support a human's weight while performing maintenance on an automotive vehicle. Traditionally, the mechanic has to kneel or bend over the quarter panel of the vehicle backwards to access underneath the dashboard. The present invention is designed to allow a user to comfortably lay supine to access underneath the dashboard. The inclusion of wheels allows users to easily approach and distance themselves from the vehicle to acquire necessary tools to perform the maintenance to the vehicle.

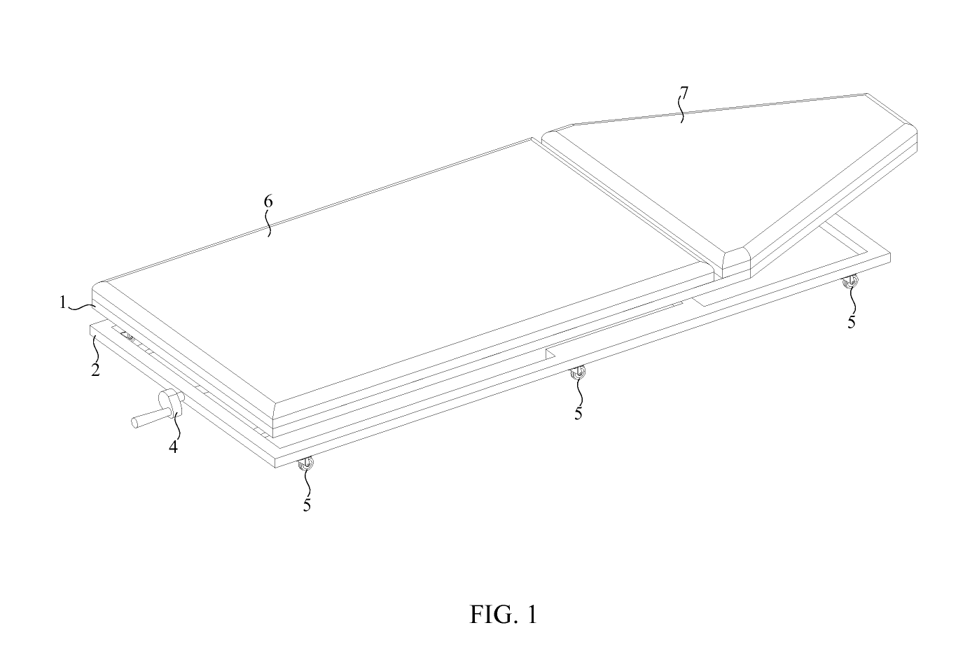

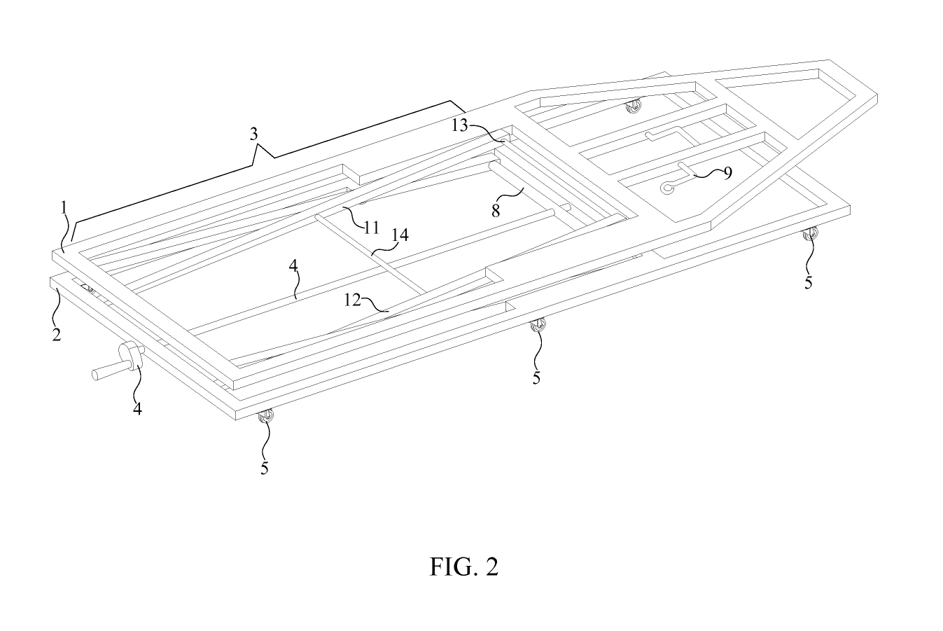

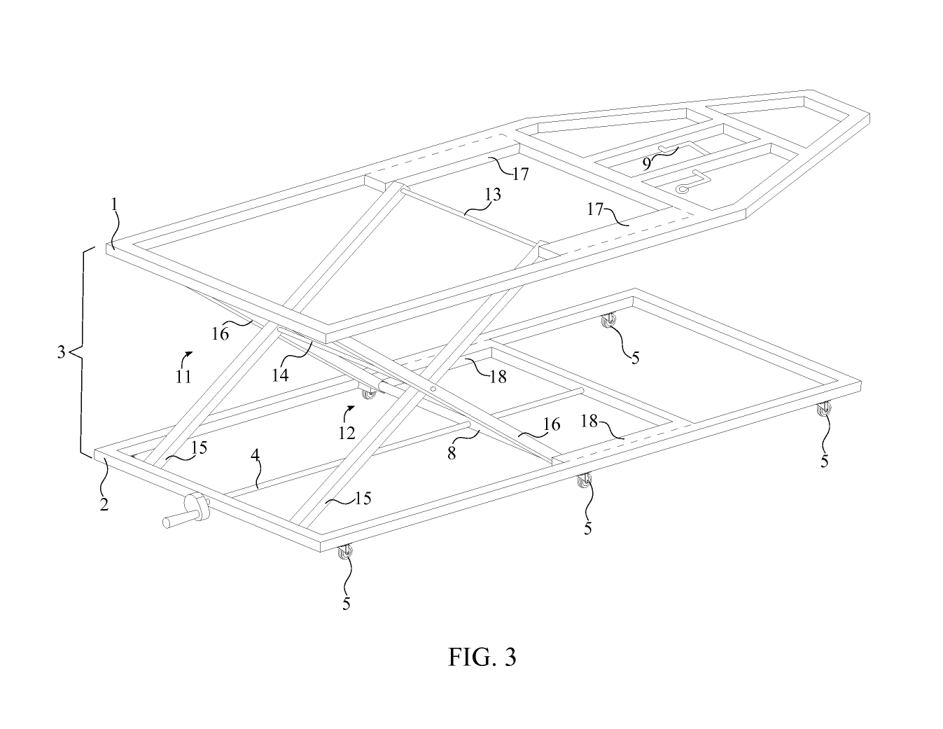

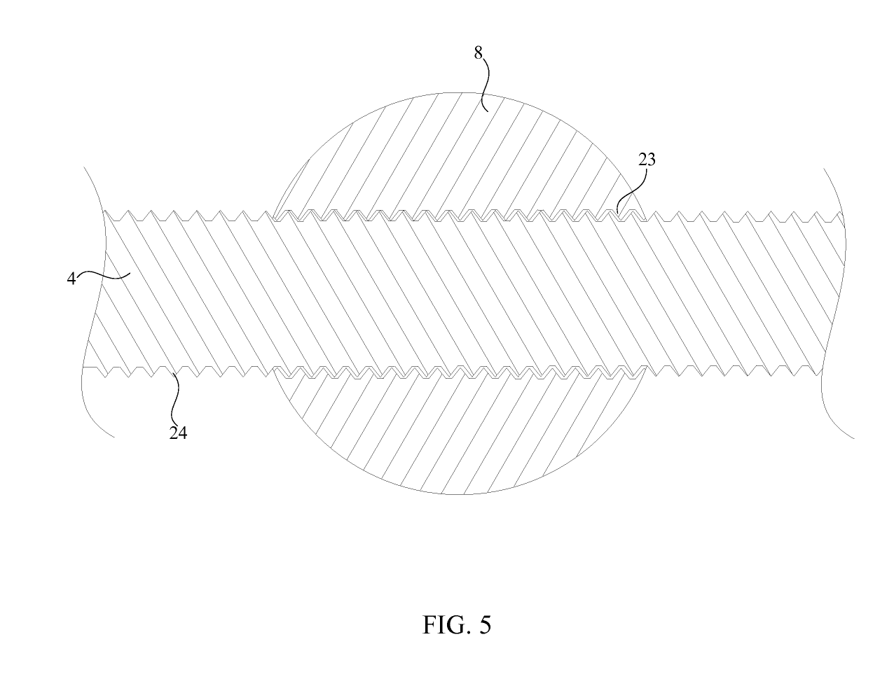

In accordance to FIG. 1, FIG. 2 and FIG. 3, the present invention comprises an upper frame 1, a lower frame 2, a scissor lift 3, a jackscrew 4, a plurality of casters 5, a support cushion 6, a headrest 7, and an actuating crossbar 8. The upper frame 1 is the direct support for the support cushion 6 and the headrest 7 which interface directly with the user. The lower frame 2 supports the upper frame 1 and the scissor lift 3 by providing a sturdy base to distribute the user's weight across, as the upper frame 1 is elevationally mounted onto the lower frame 2 by the scissor lift 3. The scissor lift 3 allows the upper frame 1 to be raised and lowered in height to allow the user access to vehicles of varying heights. The jackscrew 4 in conjunction with the actuating crossbar 8 facilitates the raising and lowering of the upper frame 1 through the scissor lift 3. The jackscrew 4 is rotatably mounted to the lower frame 2, such that the jackscrew 4 rotates freely when actuated and supported by the lower frame 2. The actuating crossbar 8 is slidably connected to the lower frame 2, where the actuating crossbar 8 is able to be maneuvered along the lower frame 2. The actuating crossbar 8 is rotatably connected to the scissor lift 3. A female-threaded hole 23 of the actuating crossbar 8 is engaged to a helical threading 24 of the jackscrew 4, as shown in FIG. 5. When the jackscrew 4 is actuated, the rotation of the helical threading 24 forces the actuating crossbar 8 along the jackscrew 4, which in turn raises and lowers the upper frame 1 through the scissor lift 3 by adjusting the width of the scissor lift 3. The plurality of casters 5 allows the present invention to be easily maneuverable around the vehicle since the plurality of casters 5 is mounted to the lower frame 2, opposite to the upper frame 1, in order to interface with a ground surface. The support cushion 6 provides a comfortable surface for the user to lay while performing maintenance as the support cushion 6 is mounted onto the upper frame 1, opposite to the lower frame 2. The headrest 7 is hingedly mounted onto the upper frame 1, opposite to the lower frame 2, such that the headrest 7 is able to be positioned into angles to the user's preference to make working under the dash easier for the user. The support cushion 6 and the headrest 7 are positioned adjacent to each other such that there is a minimal gap between the support cushion 6 and the headrest 7 providing a consistent cushioned surface for the user.

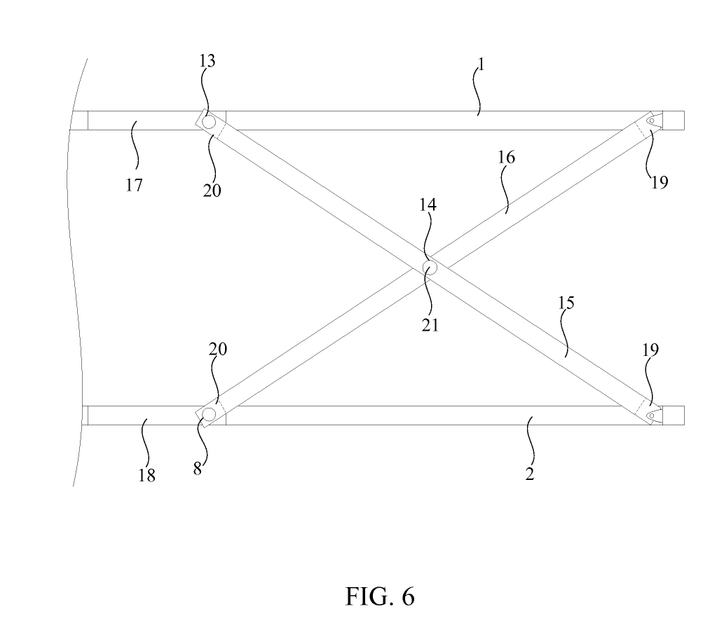

In accordance to the preferred embodiment, the scissor lift 3 comprises a first lifting mechanism 11 and a second lifting mechanism 12, as shown in FIG. 2 and FIG. 3. The first lifting mechanism 11 and the second lifting mechanism 12 are opposite to each other across the upper frame 1 and the lower frame 2, such that the first lifting mechanism 11 and the second lifting mechanism 12 evenly support the upper frame 1 onto the lower frame 2. In order to manage this aspect, the first lifting mechanism 11 and the second lifting mechanism 12 each comprise an inner support 15, an outer support 16, an upper support track 17 and a lower support track 18 in accordance to FIG. 3. The inner support 15 and the outer support 16 are pivotable struts that support the upper frame 1 onto the lower frame 2. The upper support track 17 and the lower support track 18 secure and allow the inner support 15 and the outer support 16 to slide along the upper frame 1 and the lower frame 2, respectively. The upper support track 17 is mounted adjacent to the upper frame 1. The lower support track 18 is mounted to the lower frame 2, aligned with the upper support track 17. In accordance to FIG. 6, a first end 19 of the inner support 15 is pivotably mounted to the lower frame 2, through a pinned connection preferably, while a second end 20 of the inner support 15 is rotatably and slidably connected to the upper support track 17. Similarly, a first end 19 of the outer support 16 is pivotably mounted to the upper frame 1, through a pinned connection preferably, while a second end 20 of the outer support 16 is rotatably and slidably connected to the lower support track 18. A midpoint 21 of the inner support 15 is pivotably connected to a midpoint 21 of the outer support 16 in order to restrict the movement of the inner support 15 and the outer support 16 relative to each other such that upper frame 1 is raised and lowered evenly when the jackscrew 4 is actuated.

Further in accordance to the preferred embodiment, the scissor lift 3 comprises an upper crossbar 13 and a central crossbar 14 to provide support between the first lifting mechanism 11 and the second lifting mechanism 12. The upper crossbar 13 is rotatably mounted in between the inner support 15 of the first lifting mechanism 11 and the inner support 15 of the second lifting mechanism 12. The upper crossbar 13 is slidably connected to in between the upper support track 17 of the first lifting mechanism 11 and the upper support track 17 of the second lifting mechanism 12. The second end 20 of the inner support 15 for the first lifting mechanism 11 and the second lifting mechanism 12 are rotatably and slidably connected to the upper support track 17 through the upper crossbar 13. The mechanical intergration of the upper crossbar 13 into the scissor lift 3 stabilizes the movement between the first lifting mechanism 11 and the second mechanism 12 proximal to the upper crossbar 13. The central crossbar 14 traverses through the midpoint 21 of both the outer support 16 and the inner support 15 for each the first lifting mechanism 11 and the second lifting mechanism 12. The central crossbar 14 is pivotably connected to the midpoint 21 of the outer upper and the inner support 15 for each of the first lifting mechanism 11 and the second lifting mechanism 12.

Similar to the upper crossbar 13, the actuating crossbar 8 provides additional lower support for both the first lifting mechanism 11 and the second lifting mechanism 12 and is rotatably mounted in between the outer support 16 of the first lifting mechanism 11 and the outer support 16 for the second lifting mechanism 12. The actuating crossbar 8 is slidably connected in between the lower support track 18 of the first lifting mechanism 11 and the lower support track 18 of the second lifting mechanism 12. The second end 20 of the outer support 16 for the first lifting mechanism 11 and the second lifting mechanism 12 are rotatably and slidably connected to the lower support track 18 through the actuating crossbar 8. The mechanical intergration of the actuating crossbar 8 into the scissor lift 3 stabilizes the movement between the first lifting mechanism 11 and the second mechanism 12 proximal to the actuating crossbar 8.

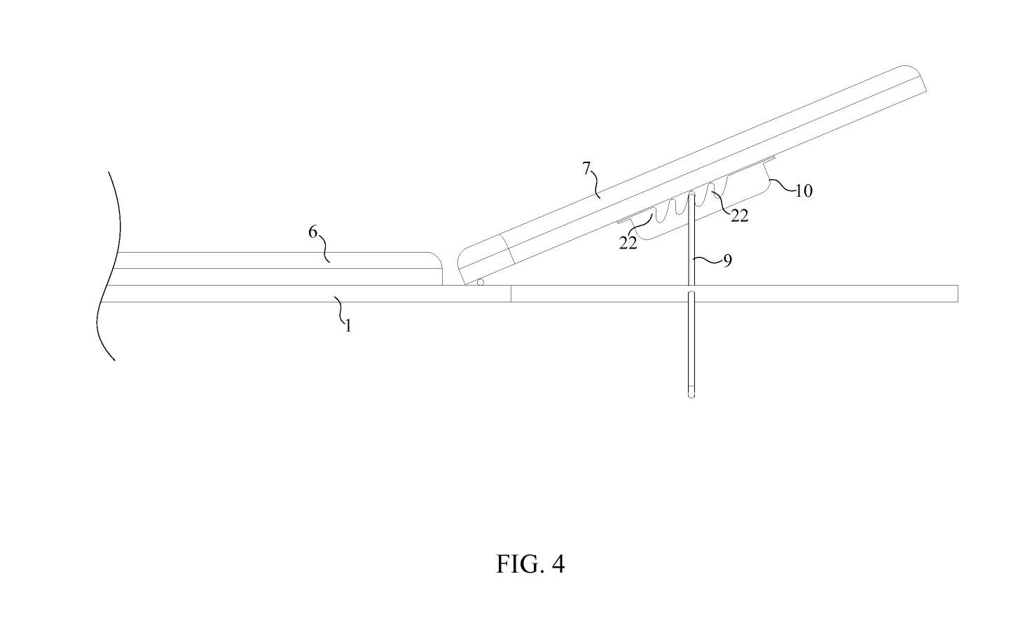

As previously mentioned, the headrest 7 is able to be positioned at discrete angles. In order to facilitate this aspect of the headrest 7, the upper frame 1 comprises a headrest support 9 in order for the headrest 7 to maintain the positioned angle. In accordance to FIG. 4, the headrest 7 comprises an angle adjustment 10 to position the headrest 7 at the discrete angles. The angle adjustment 10 is centrally mounted to the headrest 7 and adjacent to the upper frame 1. The headrest support 9 is rotatably mounted to the upper frame 1 and adjacently positioned with the headrest support 9. More specifically, the angle adjustment 10 comprises a plurality of notches 22, which are positioned along the angle adjustment 10 and oriented towards the upper frame 1. The plurality of notches 22 is positioned at several different angles such that the user is able to manually select the angle for the headrest support 9 to engage. The headrest 7 is able to be positioned into two distinct configurations, a closed configuration and an angled configuration. In the closed configuration the headrest 7 is positioned parallel to the upper frame 1 with the headrest support 9 disengaged from the plurality of notches 22. In the angled configuration, the headrest support 9 is selectively engaged with one of the plurality of notches 22 according to the user's preference of the angle for the headrest 7.

Although the invention has been explained in relation to its preferred embodiment, it is to be understood that many other possible modifications and variations can be made without departing from the spirit and scope of the invention as hereinafter claimed.

What is claimed is:

1. A vehicle service platform comprises:
an upper frame;
a lower frame;
a scissor lift;
a jackscrew;
a plurality of casters;
a support cushion;
a headrest;
an actuating crossbar;
the upper frame being elevationally mounted onto the lower frame by the scissor lift;
the plurality of casters being mounted to the lower frame, opposite to the upper frame;
the jackscrew being rotatably mounted to the lower frame;
the actuating crossbar being slidably connected to the lower frame;
the actuating crossbar being rotatably connected to the scissor lift;
a female-threaded hole of the actuating crossbar being engaged to a helical threading of the jackscrew;
the support cushion being mounted onto the upper frame, opposite to the lower frame;
the headrest being hingedly mounted onto the upper frame, opposite to the lower frame; and
the support cushion and the headrest being positioned adjacent to each other.

2. The vehicle service platform, as claimed in claim 1, comprises:
the scissor lift comprises a first lifting mechanism and a second lifting mechanism;
the first lifting mechanism and the second lifting mechanism each comprise an inner support, an outer support, an upper support track and a lower support track;
the first lifting mechanism and the second lifting mechanism being opposite to each other across the upper frame and the lower frame;
the upper support track being mounted adjacent to the upper frame;
the lower support track being mounted adjacent to the lower frame, aligned to the upper support track;
a first end of the inner support being pivotably mounted to the lower frame;
a second end of the inner support being rotatably and slidably connected to the upper support track;
a first end of the outer support being pivotably mounted to the upper frame;
a second end the outer support being rotatably and slidably connected to the lower support track; and
a midpoint of the inner support being pivotably connected to a midpoint of the outer support.

3. The vehicle service platform, as claimed in claim 2, comprises:
the scissor lift comprises an upper crossbar;
the upper crossbar being rotatably mounted in between the inner support of the first lifting mechanism and the inner support of the second lifting mechanism;
the upper crossbar being slidably connected in between the upper track of the first lifting mechanism and the upper track of the second lifting mechanism; and
the second end of the inner support for the first lift mechanism and the second lift mechanism being rotatably and slidably connected to the upper support track through the upper crossbar.

4. The vehicle service platform, as claimed in claim 2, comprises:
the scissor lift comprises a central crossbar;
the central crossbar traversing through the midpoint of both the outer support and the inner support for each the first lifting mechanism and the second lifting mechanism; and
the central crossbar being pivotably connected to the midpoint of the outer support and the inner support for each of the first lifting mechanism and the second lifting mechanism.

5. The vehicle service platform, as claimed in claim 2, comprises:
the actuating crossbar being rotatably mounted in between the outer support of the first lifting mechanism and the outer support of the second lifting mechanism;
the actuating crossbar being slidably connected in between the lower support track of the first lifting mechanism and the lower support track of the second lifting mechanism; and
the second end of the outer support for the first lift mechanism and the second lift mechanism being rotatably and slidably connected to the lower support track through the actuating crossbar.

6. The vehicle service platform, as claimed in claim 1, comprises:
the upper frame comprises a headrest support;
the headrest comprises an angle adjustment;
the angle adjustment being centrally mounted to the headrest and adjacent to the upper frame; and
the headrest support being rotatably mounted to the upper frame and adjacently positioned with the headrest support.

7. The vehicle service platform, as claimed in claim 6, comprises:
the angle adjustment comprises a plurality of notches;
the plurality of notches being positioned along the angle adjustment and oriented towards the upper frame; and
the headrest support being selectively engaged with one of the plurality of notches.

8. The vehicle service platform, as claimed in claim 6, comprises:
the headrest being positioned parallel to the upper frame.

9. A vehicle service platform comprises:
an upper frame;
a lower frame;
a scissor lift;
a jackscrew;
a plurality of casters;
a support cushion;
a headrest;
an actuating crossbar;
the upper frame comprises a headrest support;
the headrest comprises an angle adjustment;
the upper frame being elevationally mounted onto the lower frame by the scissor lift;
the plurality of casters being mounted to the lower frame, opposite to the upper frame;
the jackscrew being rotatably mounted to the lower frame;
the actuating crossbar being slidably connected to the lower frame;
the actuating crossbar being rotatably connected to the scissor lift;
a female-threaded hole of the actuating crossbar being engaged to a helical threading of the jackscrew;
the support cushion being mounted onto the upper frame, opposite to the lower frame;
the headrest being hingedly mounted onto the upper frame, opposite to the lower frame;
the support cushion and the headrest being positioned adjacent to each other;
the angle adjustment being centrally mounted to the headrest and adjacent to the upper frame; and
the headrest support being rotatably mounted to the upper frame and adjacently positioned with the headrest support.

10. The vehicle service platform, as claimed in claim 1, comprises:
the scissor lift comprises a first lifting mechanism and a second lifting mechanism;
the first lifting mechanism and the second lifting mechanism each comprise an inner support, an outer support, an upper support track and a lower support track;
the first lifting mechanism and the second lifting mechanism being opposite to each other across the upper frame and the lower frame;
the upper support track being mounted adjacent to the upper frame;
the lower support track being mounted adjacent to the lower frame, aligned to the upper support track;
a first end of the inner support being pivotably mounted to the lower frame;
a second end of the inner support being rotatably and slidably connected to the upper support track;
a first end of the outer support being pivotably mounted to the upper frame;
a second end the outer support being rotatably and slidably connected to the lower support track; and
a midpoint of the inner support being pivotably connected to a midpoint of the outer support.

11. The vehicle service platform, as claimed in claim 10, comprises:
the scissor lift comprises an upper crossbar;
the upper crossbar being rotatably mounted in between the inner support of the first lifting mechanism and the inner support of the second lifting mechanism;
the upper crossbar being slidably connected in between the upper track of the first lifting mechanism and the upper track of the second lifting mechanism; and
the second end of the inner support for the first lift mechanism and the second lift mechanism being rotatably and slidably connected to the upper support track through the upper crossbar.

12. The vehicle service platform, as claimed in claim 10, comprises:
the scissor lift comprises a central crossbar;
the central crossbar traversing through the midpoint of both the outer support and the inner support for each the first lifting mechanism and the second lifting mechanism; and
the central crossbar being pivotably connected to the midpoint of the outer support and the inner support for each of the first lifting mechanism and the second lifting mechanism.

13. The vehicle service platform, as claimed in claim 10, comprises:
the actuating crossbar being rotatably mounted in between the outer support of the first lifting mechanism and the outer support of the second lifting mechanism;
the actuating crossbar being slidably connected in between the lower support track of the first lifting mechanism and the lower support track of the second lifting mechanism; and
the second end of the outer support for the first lift mechanism and the second lift mechanism being rotatably and slidably connected to the lower support track through the actuating crossbar.

14. The vehicle service platform, as claimed in claim 1, comprises:
the angle adjustment comprises a plurality of notches;
the plurality of notches being positioned along the angle adjustment and oriented towards the upper frame; and
the headrest support being selectively engaged with one of the plurality of notches.

15. The vehicle service platform, as claimed in claim 1, comprises:
the headrest being positioned parallel to the upper frame.
